(19) United States
(12) Patent Application Publication
(10) Pub. No.: US 2009/0102443 A1
(43) Pub. Date: Apr. 23, 2009

(54) H-bridge pulse generator

(76) Inventor: Stephen Smith, Appomattox, VA (US)

Correspondence Address: James W. Hiney, Esq., P.O. Box 818, Middleburg, VA, 20118, US

(21) Appl. No.: 11/786,538

(22) Filed: Apr. 12, 2007

(51) Int. Cl. G05F 1/10

(52) U.S. Cl. 323/282

(57) ABSTRACT

A new type of circuit for driving an electromagnetic acoustic transducer (EMAT) which does not employ push-pull technology using a transformer but instant uses a novel circuit employing a series of Mosfet switches to correct all the disadvantages of using a transformer.

### BACKGROUND OF THE FIELD

In the past EMATS (electromagnetic acoustic transducers) have typically used a push-pull topology. This type of circuit provides a tone burst of current consisting of a specified number of cycles in the EMAT transmitter coil. The system would be switched on for a period of time and then switched off for a period of time, followed by the switching on for the same period of time another coil to avoid saturation of the transformer and then switching it off at the end of the cycle. This cycle produces a square wave output that can be transformed into the voltage required to drive the EMAT and its tuning components.

The historical problem with this system is that it substantially limits the range of frequencies for which sufficient drive current can be produced. Parasitic components such as stray capacitance and leakage inductance associated with the transformer can also consume power and limit the current that would otherwise be delivered to the EMAT. Furthermore, the transformer can saturate if it is pulsed in patterns other than a symmetric tone burst, thereby limiting the power delivered to the EMAT. In addition, the push pull topology cannot be used to quench the ringing of the EMAT or reflections of power from the transmission line between the pulse source and the EMAT. Atop these considerations is the addition in cost, weight and size of the pulse source, particularly when the low frequency excitations are required and the transformer costs are large.

### THE BACKGROUND ART

The U.S. patent to Flora shows a tone burst EMAT pulse source which is composed primarily of a half bridge. This circuit was designed with a minimum of components so that it could be imbedded in the EMAT thereby eliminating the transmission of high power at high frequencies over long distances. With no transforce the high frequency power transmission there would have no unwanted ringing or noise connected with a transmission line. The drawback of this design is that for the same DC voltages applied in the half bridge the resulting AC voltage across the Load is one half that of a full bridge. The “push pull” action of the half bridge upper switching device sources the DC voltage across the load on the first half of the cycle, and the lower device sinks the voltage on the second half of the cycle. The full bridge sources the DC voltage across the load with an upper and lower switch on the first half of the cycle, and on the next half cycle sources the DC voltage across the load with an upper and lower switch in reverse. The switching actions of a full bridge produces twice the AC voltage of a half bridge. The performance of the shown circuit is that it is further limited by the turn off time (storage time and fall time) of the IGBT (insulated gate bipolar transistor). The upper frequency limit for the most IGBTs is approximately 200 Khz. The recent commercially available power MOSFET (metal-oxide-semiconductor field-effect transistor) are not as limited by storage time, turn-off time and can work up to frequencies of 30 MHz.

The circuit has another drawback without a freewheeling diode to protect the switching device (IGBT). The diode redirects the current around the device during shutoff when a inductive load is opened by the switching device (IGBT) specified currently have a limited frequency response compared to recent commercially available power MOSFETS and the circuit has no freewheeling diode to protect the IGBT.

The use of an H-bridge for the core of the EMAT pulse circuitry, per this invention, eliminates the drawbacks described above. H=bridge configurations have been used in the past in DC power supplies, power conversion equipment and motor control below 500 Hz. It typically is used to convert DC power to AC power or pulsating DC power for power supplies, power conversion use and motor control However, it has never been used as in the current setting and this use is novel and unique.

### SUMMARY OF THE INVENTION

This invention is an electronic circuit that produces greater output power, increased efficiency, a wider frequency response and reduces ring-down noise in a physically smaller package compared to RF] pulse sources for EMATS. The invention is an electronic circuit without the need of an output transformer that produces greater output power, increased efficiency, a wider frequency response and reduces ring-down noise in a physically smaller package compared to conventional RF pulsers for EMATS. Specifically the H-bridge circuit topology provides several advantages for the EMAT pulse source. This circuit can produce transmitter pulses that are normally impeded by the transformer that is required with the push pull design. The output impedance of the design will be low with the upper two switches closed or the lower two switches closed.

When a transformer is required, the switching of the transformer must not exceed the volt-second balance (the AC current applied to the transformer core must be equal for the first positive cycle and the next negative cycle) or saturation of the transformer will occur. Transformers can be designed with significant turns to alleviate the saturation at a given frequency and which adds additional parasitic elements, i.e., stary capacitance and inductance, which inhibit high frequency operation. In the push pull design (shown in FIG. 1) is the type of tone burst amplifier in use today. The driver's turn on Q1 and Q2 in an alternating pattern to produce an AC voltage that is applied to the transformer, to produce the high voltage needed for EMATS. The push pull design has several drawbacks in its operation that impedes performance. Transformers can be designed with significant turns to alleviate the saturation at a given frequency which adds additional parasitic elements such as stray capacitance and inductance which inhibit high frequency operation. Such a condition occurs when the leakage inductor in the transformer increases which can be defined as E=Ldi/dt. The current has to slew over a given time period and the voltage will be larger to slew in less time. As the leakage inductance increases the current rise is slower over a given period of time, which results in less power being transferred from the primary of the transformer to the secondary of the transformer. This ration is needed to step-up the voltage from the 200 peak DC to the 600 peak DC (peak positive cycle to peak negative cycle=1200 V p-p) When the ratio is not ideal more turns on the secondary add a leakage inductor to the secondary of the transformer.

The present invention removes the transformer and is only limited by the switching characteristics of the output devices without the inhibiting transformer parasitics. Another benefit of the present invention is the propagation delay to output is reduced by removal of the transformer. The currents flowing though the transformer with the parasitic components create an undesirable phase delay that is reduced without a transformer. The parasitic components also create an undesirable ringing when the switches turn on the transformer which appear in the output that is removed by the instant invention design. The high frequency Mosfets (metal-oxide semiconductor field-effect transistor used, have very low storage time and turn off time)] used in the H-bridge are rated for the load current and voltage rating of at least 800 volts DC to prevent failures This is an important benefit of using an H-bridge instead of the old design with a transformer as the voltage across the devices would have to be twice the voltage for a given bus] voltage. This is a benefit of using an H-bridge instead of the original design, for the voltage across the devices would have to be twice the voltage for a given buss voltage (in the push pull design, the voltage applied to the transformer is transferred to the open switch when the other switch is closed which results in the supplied voltage and the transformer voltage=2× the voltage to the push pull) which limits the choices of electronic components that can be used.

### OBJECTS OF THE INVENTION

An object of this invention it to provide an H-bridge pulse source for EMATS which is superior over past pulse sources, and

It is another object of this invention to provide an EMAT pulse source that has increased efficiency over past sources, and

It is a still further object of this invention to a wider frequency pulse source for EMATS, and

Still further, it is an object of this invention to provide a pulse source which reduces the ring-down noise in an EMAT system, and

Yet another object of this invention is to provide a pulse source for EMATS that is in a physically small package, and

A further object of this invention is to provide a pulse source for EMATS without the use of a transformer, and

Another object of this invention is to provide a pulse source for an EMAT which eliminates parasitic components in an EMAT which cause phase delay and undesirable ringing, and

A major object of this invention is to produce a pulse source which substantially increases the range of frequencies which can be used to drive an EMAT, and

Another major object of this invention is to provide a pulse source for an EMAT which can produce, CHIRP (a low frequency tone increasing to a high frequency tone), a rectangular window tone burst (a steady frequency for several cycles then stops for a period of time and repeats for a steady frequency for several cycles, and/or Barker Code (a short group of various positives and negative cycles at a given frequency, then stops for a period of time and repeats) wave forms.

These and other objects of the invention will become apparent when reference is had to the accompanying drawings in which

### BRIEF DESCRIPTION OF THE DRAWINGS

FIG. 1 is a schematic representation of the push pull high frequency tone burst.

FIG. 2 is a schematic representation of an H Bridge for high frequency tone burst.

FIG. 3 is a schematic representation of an alternate freewheeling diode arrangement.

FIG. 4 is a schematic representation of a high frequency tone burst.

FIG. 5 is a schematic representation of a CHIRP output (a low frequency tone increasing to a high frequency tone).

FIG. 6 is a schematic representation of a CODE output (a short group of various positive and negative cycles at a given frequency, then stops for a period of time and repeats.)

FIG. 7 is a schematic representation of a Modulated output (a short group of various positive and negative cycles at a given frequency, then the pulses are “shortened” to provide narrow pulses to reduce output power.

FIG. 8 is a schematic representation of a Single Pulse output (a short positive cycle at a given frequency, then stops for a period of time and repeats)

FIG. 9 is a schematic representation of a Phase Shift Modulation output (a short group of various positive and negative cycles at a given frequency, then ½ of the H Bridge is modulated out of phase which “shortens” the combined output pulses to reduce output power, and

FIG. 10 is a schematic representation of a parallel of the H bridge.

### DETAILED DESCRIPTION OF THE PREFERRED EMBODIMENTS

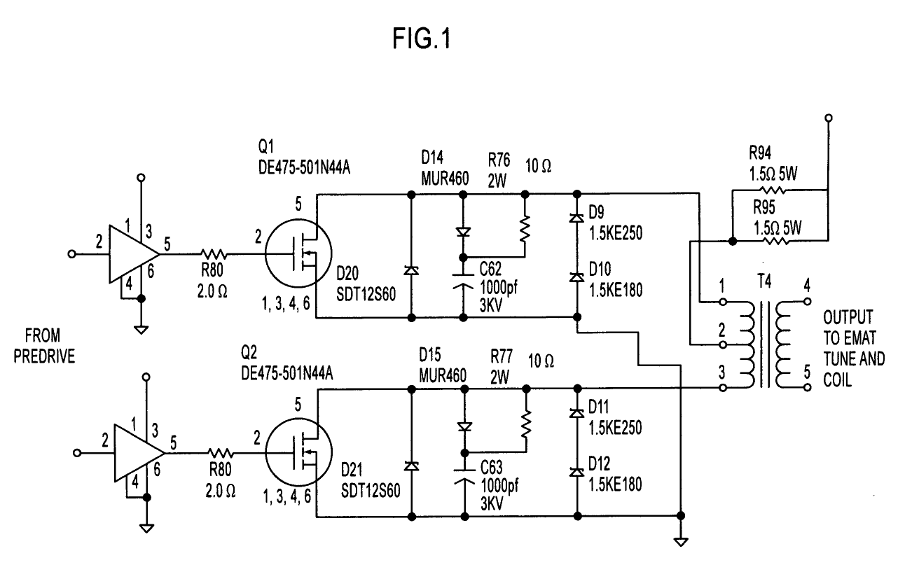

FIG. 1 shows a push pull topology typically used in an EMAT. This circuit provides a tone burst of current consisting of a specified number of cycles in an EMAT transmitter coil. The operation is for switch Q1 to be turned on for period of time and then switched off for a period of time, followed by the switching on for Q2 for the same period of time to avoid saturation of the transformer and then the Q2 is switched off at the end of the cycle. This operation produces a square wave output which can be transformed to the voltage required to drive the EMAT and its timing components. The use of the transformer however limits the range of frequencies for which sufficient drive current can be produced. Parasitic components such as stray capacitance and leakage inductance associated with the transformer can also consume power and limit the current that would otherwise be delivered to the EMAT. If the transformer is pulsed in a pattern other than a symmetric tone burst, it can limit the power delivered to the EMAT.

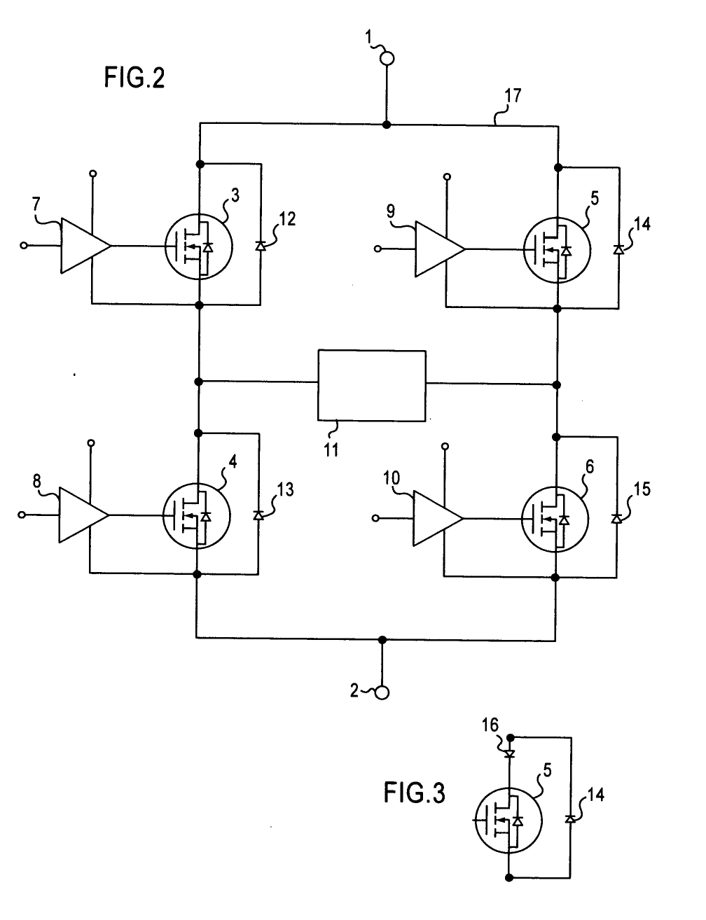

FIG. 2 shows the schematic diagram of the primary embodiment of the instant invention. The H-bridge circuit 17 eliminates the transformer and provides a means for high speed switching, bipolar high voltage, variable frequency excitation and elimination of unwanted oscillations frequency, reversible output, and quenching of output with various modes of operation for use of transmission of various outputs for EMAT transducers.

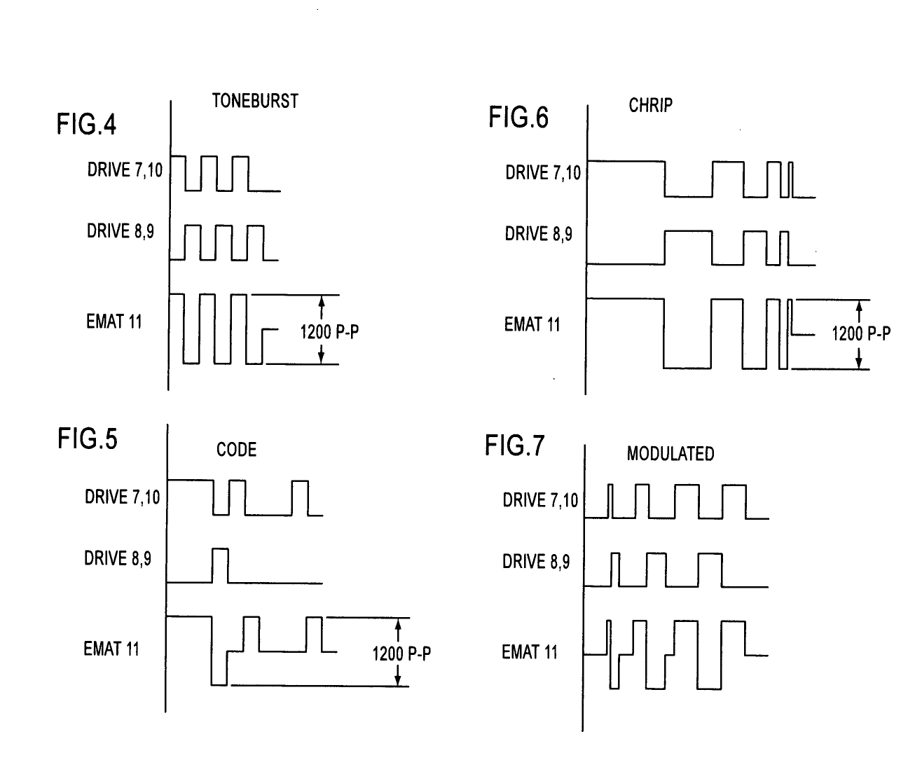

The operation starts with a voltage source of approximately 650 volts DC being applied positive from point 1 to point 2. The gate drivers 7 and 10, which are of the optical type (needed for high frequency drive) apply the voltage to Mosfet 3 and Mosfet 6. The result is a current flowing from point 1 through Mosfet 3 to the EMAT transducer 1 and then though Mosfet 6 to point 2. This results in a positive output across the EMAT transducer. The on-time of optical gate drivers 7 and 10 is on time determined by the requirements of the users frequency and pulse period. The frequency and pulse width is decided and ½ of the cycle applied to the gates of Mosfet 3 and Mosfet 6 by drivers 7 and 10. The drivers 7 and 10 are turned off at the end of the ½ cycle, the delay of approximately 5% of the ½ cycle is waited, the optical gate drivers 8 and 9 are turned on which turn on Mosfets 4 and Mosfet 5 for the remaining ½ cycle and the delay of approximately 5% of the ½ cycle is waited before drivers 7 and 10 can begin again. The current is driven positive for ½ cycle and then reversed for ½ a cycle and FIG. 4 shows the resulting waveform. The delay of 5% allows for the Mosfet's storage time and turn off time (which is the period of time it takes to completely turn off the Mosfet) If this time was violated the condition called “shoot through” in which current is still flowing in a Mosfet and another is turned on in the circuit which diverts current through the Mosfets instead of the load. An example is Mosfet 3 is on and Mosfet 4 turns on before Mosfet 3 has turned off. The result is the current flowing from point 1 to point 2 (which is the DC supply voltage) results in a possible failure of the devices. When all of the Mosfets are turned off by the gate drivers, 7, 10, 8, and 9, the output across 11 (EMAT) becomes an open. The impedance (open circuit resistance) MOSFET H bridge as seen back from the EMAT is almost infinite resulting in the end of transmission of the signal (there is no current flow into the EMAT).

Freewheeling diodes 12, 13, 14 and 15 provide an alternate path for current Mosfets when the current continues to flow from the EMAT which is an inductive load, during turn off of the Mosfets. The Mosfet structure has an “intrinsic diode” which will conduct current that is applied in the reverse direction across its drain and source (see FIG. 2). If the diodes were not present during the reverse current, the Mosfet may conduct the current longer than the delay time, which will cause the condition, called “shoot through”. As explained above, this condition results in a possible failure of the devices.

An alternative freewheeling Mosfet diode circuit is shown in FIG. 3. This circuit can be used in place of the Mosfet diode circuit shown in FIG. 2. The purpose of this circuit si the same. The diode 14 redirects the current around the Mosfet and diode 16 allows current only in the positive direction to flow in the Mosfet. If the EMAT transducer (which is inductive) is operated below, at and above resonance, both freewheeling diode circuits will protect the Mosfets during reverse current flow of EMAT transducer.

The H-bridge shown in FIG. 2 can quench the EMAT transducer 11 if needed to prevent any ring back. The function is the same as mentioned above with the following exceptions; In FIG. 3, when Mosfets 4 and 5 are about to turn off, Mosfet 5 turns off while Mosfet 4 stays on and, after a delay of approximately 5% of the on time which allows for the Mosfets storage time and turn off time (which is the period of time it takes to completely turn off the Mosfet) Mosfet 6 is turned on. The Mosfets are kept on for a period determined by the time needed to produce a low impedance path for the EMAT transducer 11 to end any substantial transmission.

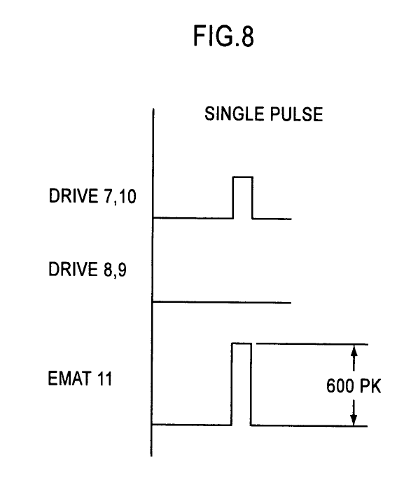

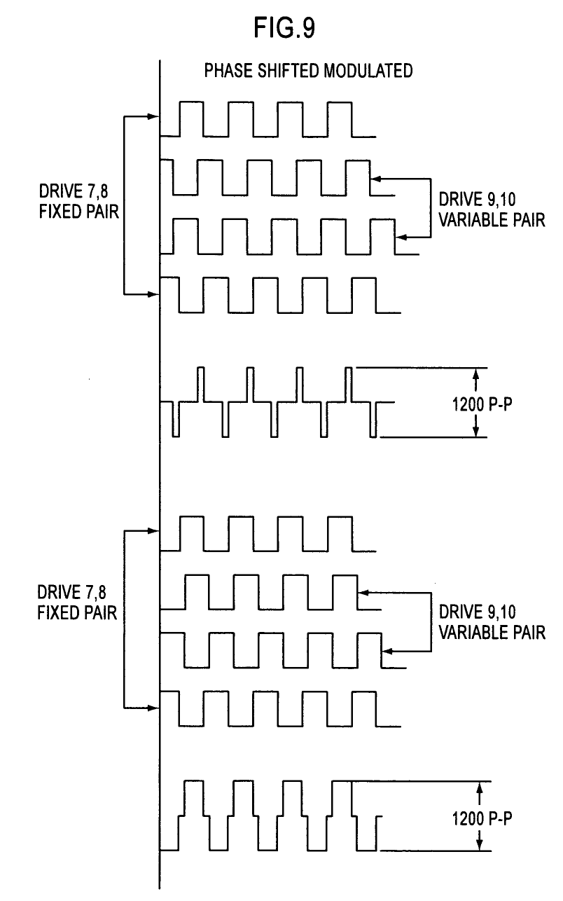

Several additional drive schemes are shown in FIGS. 4, 5, 6, 7, 8 and 9. These drive schemes represent various outputs useful in EMAT transducer applications. It is possible to parallel the H-bridges with two methods for higher output power and longer duty cycles which are;

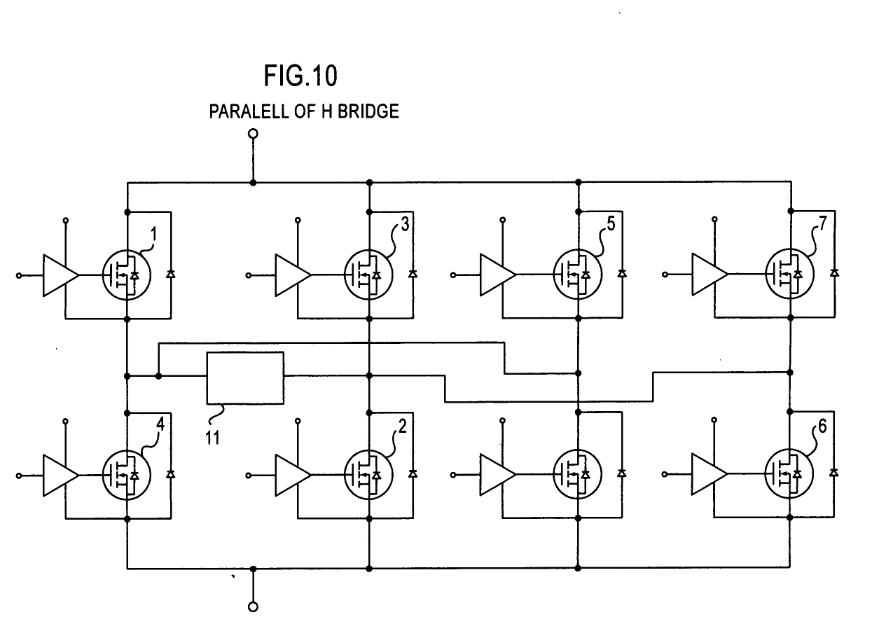

Directly paralleling another circuit as shown in FIG. 10 (this is the same FIG. 2 with twice the Mosfets and drive circuits) and realizing Mosfets share a portion of the current driving the EMAT although at these frequencies it will not be equal.

The other method is to sequentially switch the two or more H bridges in a different fashion is also shown in FIG. 10. Mosfet 1 and Mosfet 2 are switched on for a period of time determined by the requirements of the user's frequency and pulse period. Mosfet 1 and Mosfet 2 are switched off. Mosfet 3 and 4 are switched on for a time determined by the requirements of the users frequency and pulse period. Mosfet 3 and 4 are switched off. Mosfet 5 and Mosfet 6 are switched on for a period of time determined by the requirements of the users frequency and pulse period. Mosfet 5 and 6 are switched off, Mosfet sd 7 and 8 are switched on for a time determined by the requirements of the users frequency and pulse period. Mosfets 7 and 8 are then switched off. When the Mosfet are all cycled through the sequence beings at Mosfet 1.

The output will be the same for any of the figure relating to the H Bridge. The advantage to switching in this manner is that the currents are equal but the time that any Mosfet is on is one half of the time in that of a single configuration. This configuration can be expanded to twice that which allows Mosfets to be on only one quarter (¼) of the time as that of a single H bridge.

While only certain specific embodiments of this invention have been shown in detail it will be obvious to those of ordinary skill in the art that many changes and additions can be made without departing from the scope of the appended claims.

What is claimed is:

1. A transmitting switching circuit for an electromagnetic acoustic transducer having a coil (EMAT) comprising:
driving means for driving the EMAT without a transformer at desired high frequencies, said means including
a first means for selectively exciting and redirecting the electrical current and connected to the EMAT coil,
a second means for selectively starting current flow and ending current flow connected by said first means.

2. A switching circuit as in claim 1 wherein said first means for selectively exciting and redirecting the electrical current comprises optical drivers.

3. A switching circuit as in claim 1 wherein said first means for selectively redirecting the electrical current comprises Mosfet output drivers.

4. A switching circuit according to claim 3 wherein said first means for selectively redirecting the reverse electrical current comprises freewheeling diodes positioned across the Mosfet output devices.

5. A switching circuit according to claim 1 wherein the output voltage is 600 volts peak positive and 600 volts peak negative.

6. A method of signal drive sequence to produce a tone burst output for an electromagnetic acoustic transducer (EMAT) circuit containing a tuning capacitor and a coil, said method comprising:
applying an initial tone burst across the tuning capacitor and EMAT coil.

7. A method as in claim 6 wherein said method further includes
resonating the inductance and resistance of the EMAT coil with the tuning capacitor to a desired frequency.

8. A method of increasing power output for an electromagnetic acoustic transducer (EMAT) comprising
providing parallel outputs for said EMAT using an H-bridge pulse generator.

9. A method as in claim 8 and including providing a Chirp output for said EMAT.

10. A method as in claim 8 and including providing a Code Output for said EMAT.

11. A method as in claim 8 and including providing sequential switching of parallel outputs to increase power output for said EMAT.

12. A method as in claim 8 and including providing a signal drive sequence to produce a phase shift modulated output for said EMAT which, during resonance at load, produces a lossless Hemming pattern.

13. A transmitting switching circuit for electromagnetic acoustic transducers (EMATS) with a coil without a transformer, said comprising
driving means for driving the EMAT without a transformer,
first and second means for, respectively, selectively redirecting current to the EMAT coil and selectively starting and ending current flow, said second means being operatively connected to said first means.

14. A switching circuit as in claim 13 and including four Mosfet output devices which comprise the first and second means.

15. A switching circuit as in claim 14 wherein the output impedance of the circuit is low with two of the switches closed.

16. A switching circuit as in claim 13 wherein the first and second means have very low storage time and turn off time.

17. A switching circuit as in claim 16 wherein said first and second means are metal-oxide semiconductor field-effect transistors.

18. A switching circuit as in claim 13 wherein said circuit can produce a low frequency tone increasing to a frequency tone (CHIRP).

19. A switching circuit as in claim 13 wherein said circuit can produce a short group of various positives and negative cycles at a given frequency, then stop for a period of time and then repeat.

20. A switching circuit as in claim 13 wherein said circuit can produce a rectangular window tone burst.

21. A switching circuit as in claim 20 wherein said tone burst is achieved by turning off and on multiple switches.

22. A switching circuit as in claim 21 wherein said switches are optical drivers.

23. A switching circuit as in claim 22 wherein there are four switches.

24. A switching circuit as in claim 23 wherein there are twice the number of switches in a parallel circuit.
